(19) United States
(12) Patent Application Publication
(10) Pub. No.: US 2025/0185000 A1
(43) Pub. Date: Jun. 5, 2025

(54) LATENCY SAVING DESIGN AND TRIGGER FOR MAC CE FOR MEASUREMENT GAP

(71) Applicant: Telefonaktiebolaget LM Ericsson (publ), Stockholm (SE)

(72) Inventors: Ritesh Shreevastav, Upplands Väsby (SE); Mattias Bergström, Singapore (SG)

(21) Appl. No.: 18/840,240

(22) PCT Filed: Feb. 21, 2023
(86) PCT No.: PCT/IB2023/051580

§ 371 Date: Aug. 21, 2024

Related U.S. Application Data
(60) Provisional application No. 63/312,281, filed on Feb. 21, 2022.

(51) Int. Cl. H04W 72/1268; H04W 24/10; H04W 64/00; H04W 80/02

(52) U.S. Cl. CPC H04W 72/1268; H04W 24/10; H04W 64/00; H04W 80/02

(57) ABSTRACT

Systems and methods for triggering Medium Access Control (MAC) Control Element (CE) for measurement gap are provided. In some embodiments, a method performed by a User Equipment (UE) for requesting gap status change includes: generating a MAC CE that indicates a preference for a Measurement Gap (MG) state; receiving an indication from base station granting permission to the UE to trigger a scheduling request; acquiring an uplink grant by triggering a scheduling request; and after acquiring the uplink grant, transmitting the MAC CE that indicates a preference for a MG state. In this way, the UE can dispatch the MG activation/deactivation with a very low latency; i.e., as soon as the MAC CE are available; the availability of MG MAC CE can trigger transmission; sending SR and obtaining grant to send the MAC CE. A common MAC CE design for measurement gap activation/deactivation and BSR saves latency and reduces overhead.

### RELATED APPLICATIONS

This application claims the benefit of provisional patent application Ser. No. 63/312,281, filed Feb. 21, 2022, the disclosure of which is hereby incorporated herein by reference in its entirety.

### TECHNICAL FIELD

The present disclosure relates to managing a measurement gap.

### BACKGROUND

Positioning has been a topic in Long Term Evolution (LTE) standardization since Release 9 of the 3rd Generation Partnership Project (3GPP). The primary objective was initially to fulfill regulatory requirements for emergency call positioning but other use case like positioning for Industrial Internet of Things (I-IoT) are becoming important. Positioning in New Radio (NR) is supported, e.g., by the architecture shown in FIG. 1. The Location Management Function (LMF) is the location node in NR. There are also interactions between the location node and the gNodeB via the NR Positioning Protocol A (NRPPa). The interactions between the gNodeB and the device is supported via the Radio Resource Control (RRC) protocol, while the location node interfaces with the User Equipment (UE) via the LTE Positioning Protocol (LPP). LPP is common to both NR and LTE. It will be appreciated that while FIG. 1 shows both a gNB and an ng-eNB, both may not always be present. Further, when both the gNB and the ng-eNB are present, the NG-C is generally only present for one of them.

In the legacy LTE standards, the following techniques are supported:
Enhanced Cell ID (E-CID). Essentially cell ID information to associate the device to the serving area of a serving cell, and then additional information to determine a finer granularity position.
Assisted Global Navigation Satellite System (GNSS). GNSS information retrieved by the device, supported by assistance information provided to the device from Evolved Serving Mobile Location Center (E-SMLC)
OTDOA (Observed Time Difference of Arrival). The device estimates the time difference of reference signals from different base stations and sends to the E-SMLC for multi-lateration.
UTDOA (Uplink TDOA). The device is requested to transmit a specific waveform that is detected by multiple location measurement units (e.g., an eNB) at known positions. These measurements are forwarded to E-SMLC for multilateration.

In NR Rel. 16, a number of positioning features were specified including reference signals, measurements, and positioning methods:

### Reference Signals:

A new DownLink (DL) reference signal, the NR DL PRS (Positioning Reference Signal) was specified. The main benefit of this signal in relation to the LTE DL PRS is the increased bandwidth, configurable from 24 to 272 resource blocks (RBs), which gives a big improvement in time of arrival (TOA) accuracy. The NR DL PRS can be configured with a comb factor of 2, 4, 6 or 12. Comb-12 allows for twice as many orthogonal signals as the comb-6 LTE PRS. Beam sweeping is also supported on NR DL PRS in Rel-16.
A new UL reference signal, based on the NR UL Sounding Reference Signal (SRS) was introduced and called “SRS for positioning”. The Rel. 16 NR SRS for positioning allows for a longer signal, up to 12 symbols (compared to 4 symbols in Rel. 15 SRS), and a flexible position in the slot (only last six symbols of the slot can be used in Rel. 15 SRS). It also allows for a staggered comb resource element (RE) pattern for improved TOA measurement range and for more orthogonal signals based on comb offsets (comb 2, 4 and 8) and cyclic shifts. The use of cyclic shifts longer than the Orthogonal Frequency Division Multiplexed (OFDM) symbol divided by the comb factor is, however, not supported by Rel. 16 despite that this is the main advantage of comb-staggering at least in indoor scenarios. Power control based on neighbor cell Synchronization Signal Block (SSB)/DL PRS is supported as well as spatial Quasi-CoLocation (QCL) relations towards a Channel State Information Reference Signal (CSI-RS), an SSB, a DL PRS, or another Sounding Reference Signal (SRS).

### Positioning Techniques

### NR Positioning Supports the Following Methods:

Methods already in LTE and enhanced in NR:
   DL TDOA (Downlink TDOA)
   E-CID
   RAT independent methods (based on non-3GPP sensors such as GPS, pressure sensors, Wifi signals, Bluetooth, etc).
   UL TDOA (Uplink TDOA)
Methods newly introduced methods in NR:
   Multicell RTT: the LMF collects RTT (round trip time) measurement as the basis for multilateration.
   DL angle of departure (AoD) and UL angle of arrival (AoA), where multilateration is done using angle and power (RSRP) measurements

### Measurements:

### In NR Rel. 16, the Following UE Measurements are Specified:

DL Reference Signal Time Difference (RSTD), allowing for e.g., DL TDOA positioning
Multi cell UE Rx-Tx Time Difference measurement, allowing for multi cell round trip time (RTT) measurements
DL PRS Reference Signal Receive Power (RSRP)

### In NR Rel. 16, the Following gNB Measurements are Specified

UpLink Relative Time of Arrival (UL-RTOA), useful for UL TDOA positioning
gNb Rx-Tx time difference, useful for multi cell RTT measurements
UL SRS-RSRP
Angle of Arrival (AoA) and Zenith angle of Arrival (ZoA)

### Signals Configurations:

In NR Rel-16, the DL PRS is configured by each cell separately, and the location server (i.e., LMF) collects all configuration via the NRPPa protocol, before sending an assistance data (AD) message to the UE via the LPP protocol. In the uplink, the SRS signal is configured in RRC by the serving gnodeB, which in turn forwards appropriate SRS configuration parameters to the LMF upon request.

### Rel-16 NR DL PRS is Organized in a 3-Level Hierarchy:

PRS frequency layer (PFL): gathers PRS resource sets from (potentially) multiple base station, having common parameters in common. If two resource sets are in the same frequency layer, they:
   Operate in the same band with the same subcarrier spacing
   Have the same comb factor
   Have the same starting PRB and bandwidth
PRS Resource set: corresponds to a collection of PRS beams (resources) which are all originating from the same Transmission and reception point (TRP). All resource in the same set have the same comb factor
PRS resource: correspond to a beam transmitting the PRS

### Measurement Gap

In release 16, the PRS-based measurements (including PRS RSRP, RSTD for OTDOA and UE Rx-Tx for RTT) are all made in the presence of measurement gaps. During a measurement gap, the UE can expect that the network will not transmit any data and thus the UE can tune itself specifically to measure the PRS. For example, to measure PRS (i.e., DL PRS), the UE will potentially utilize a different bandwidth than the active bandwidth part it is configured with to receive data.

If the UE requires measurement gaps for performing the requested location measurements while measurement gaps are either not configured or not sufficient, or if the UE needs gaps to acquire the subframe and slot timing of the target E-UTRA system before requesting measurement gaps for the inter-RAT RSTD measurements, the UE sends an RRC Location Measurement Indication message to the serving gNB as illustrated in FIG. 2. The message indicates that the UE is going to start location measurements, or that the UE is going to acquire subframe and slot timing of the target E-UTRA system, and includes information required for the gNB to configure the appropriate measurement gaps. When the gNB has configured the required measurement gaps the UE performs the location measurements or timing acquisition procedures.

When the UE has completed the location procedures which required measurement gaps, the UE sends another RRC Location Measurement Indication message to the serving gNB. The message indicates that the UE has completed the location measurements or timing acquisition procedures.

In NR, measurement gap pattern (MGP) is used by the UE for performing measurements on cells of the non-serving carriers (e.g., inter-frequency carrier, inter-RAT carriers etc.), may also be used for measurements on cells of the serving carrier in some scenarios (e.g., if the measured signals (e.g., SSB) are outside the bandwidth part (BWP) of the serving cell) or for positioning measurements on a positioning frequency layer (PFL). The UE is scheduled in the serving cell only within the BWP. During the gap the UE cannot be scheduled for receiving/transmitting signals in the serving cell. A measurement gap pattern is characterized or defined by several parameters: measurement gap length (MGL), measurement gap repetition period (MGRP), measurement gap time offset (MGTO) with respect to reference time (e.g., slot offset with respect to serving cell's SFN such as SFN=0), measurement gap timing advance (MGTA) etc. An example of MGP is shown in FIG. 3. As an example, MGL can be 1.5, 3, 3.5, 4, 5.5 or 6 ms, and MGRP can be 20, 40, 80 or 160 ms. Such type of MGP is configured by the network node and is also called as network controlled or network configurable MGP. Therefore, the serving base station is fully aware of the timing of each gap within the MGP.

In NR there are two major categories of MGPs: per-UE measurement gap patterns and per-FR measurement gap patterns. In NR, the spectrum is divided into two frequency ranges namely FR1 and FR2. FR1 is currently defined from 410 MHz to 7125 MHz. FR2 range is currently defined from 24250 MHz to 52600 MHz. In another example FR2 range can be from 24250 MHz to 71000 MHz. The FR2 range is also interchangeably called as millimeter wave (mmwave) and corresponding bands in FR2 are called as mmwave bands. In future more frequency ranges can be specified e.g., FR3. An example of FR3 is frequency ranging above 52600 MHz or between 52600 MHz and 71000 MHz or between 7125 MHz and 24250 MHz.

Concurrent measurement gap pattern (C-MGP) or interchangeably called as concurrent gaps or concurrent measurement gaps are also being specified. C-MGP comprises of multiple measurement gap patterns (e.g., 2 or more MGPs) which can be configured by the network node using the same or different messages (e.g., same or different RRC messages). C-MGP may be used for multiple different types of measurements or for other scenarios such in multi-USIM operation. For example, in multi-USIM operation the UE may be configured with one or more measurement gap patterns for performing measurements on each of the plurality of the network. For example, network A (e.g., by serving cell A) may configure the UE with one or more MGPs for performing measurements on one or more cells of the network B. These MGPs may also be termed as concurrent MGP (C-MGP). Pre-configured measurement gaps (Pre-MG) are also being specified as part of the Rel-17 Measurement Gaps enhancement WI. The objective is to allow the configuration of “deactivated” measurement gaps, i.e., the UE only uses the configured gaps to perform measurements under certain situations. Hence the term “pre-configured” measurement gaps. This differs from the legacy procedure, since for this case, as such only one measurement gap can be configured; i.e not possible to provide multiple measurement gap configuration at the same time.

### Current Gap Configuration Procedure

RRC message is used to configure measurement gap; the below information element is used
MeasGapConfig
   The IE MeasGapConfig specifies the measurement gap configuration and controls setup/release of measurement gaps.

MeasGapConfig information element

-- ASN1START
-- TAG-MEASGAPCONFIG-START

| | |
|---|---|
| MeasGapConfig ::= | SEQUENCE { |
| gapFR2 | SetupRelease { GapConfig } |

```
OPTIONAL, -- Need M
  ...,
  [[
```

| | |
|---|---|
| gapFR1 | SetupRelease { GapConfig } |

OPTIONAL, -- Need M

| | |
|---|---|
| gapUE | SetupRelease { GapConfig } |

OPTIONAL -- Need M
]]
}

| | |
|---|---|
| GapConfig ::= | SEQUENCE { |
| gapOffset | INTEGER (0..159), |
| mgl | ENUMERATED {ms1dot5, ms3, ms3dot5, ms4, ms5dot5, ms6}, |
| mgrp | ENUMERATED {ms20, ms40, ms80, ms160}, |
| mgta | ENUMERATED {ms0, ms0dot25, ms0dot5}, |

```
  ...,
  [[
```

| | |
|---|---|
| refServCellIndicator | ENUMERATED {pCell, pSCell, mcg-FR2} |

```
OPTIONAL -- Cond NEDCorNRDC
  ]],
  [[
```

| | |
|---|---|
| refFR2ServCellAsyncCA-r16 | ServCellIndex |

OPTIONAL, -- Cond AsyncCA

| | |
|---|---|
| mgl-r16 | ENUMERATED {ms10, ms20} |

OPTIONAL -- Cond PRS
]]
}
-- TAG-MEASGAPCONFIG-STOP
-- ASN1STOP

RAN1 has decided that for latency savings instead of RRC, a MAC Control element can be used.
Preconfiguration of MG(s) in RRC is supported from RAN1 perspective.
   Each MG in the preconfiguration is associated with an ID
   The information in the UL MAC CE for MG activation request by the UE can be one ID associated with the preconfiguration of the MG

Support the following option (from the agreement made in RAN1 #106-e) for a new MG activation procedure to be performed by the gNB for the purpose of positioning.
Option 2: DL MAC CE
FFS: Deactivation process

Further below is RAN1 agreement for measurement gap configuration where instead of RRC message UE sends the gap request using UL MAC CE.
Preconfiguration of MG(s) in RRC is supported from RAN1 perspective.
   Each MG in the preconfiguration is associated with an ID
   The information in the UL MAC CE for MG activation request by the UE can be one ID associated with the preconfiguration of the MG
   Send an LS to RAN2 and RAN3

### Scheduling Request

The Scheduling Request (SR) is used for requesting UL-SCH resources for new transmission. The MAC entity may be configured with zero, one, or more SR configurations. An SR configuration consists of a set of PUCCH resources for SR across different BWPs and cells.

### Buffer Status Report

The Buffer Status reporting (BSR) procedure is used to provide the serving gNB with information about UL data volume in the MAC entity. RRC configures the following parameters to control the BSR:
periodicBSR-Timer;
retxBSR-Timer;
logicalChannelSR-DelayTimerApplied;
logicalChannelSR-DelayTimer;
logicalChannelSR-Mask;
logicalChannelGroup.
   Each logical channel may be allocated to an LCG using the logicalChannelGroup. The maximum number of LCGs is eight.
   The MAC entity determines the amount of UL data available for a logical channel according to the data volume calculation procedure in TSs 38.322 [3] and 38.323 [4].

### A BSR Shall be Triggered if any of the Following Events Occur:

UL data, for a logical channel which belongs to an LCG, becomes available to the MAC entity; and either
   this UL data belongs to a logical channel with higher priority than the priority of any logical channel containing available UL data which belong to any LCG; or
   none of the logical channels which belong to an LCG contains any available UL data.
in which case the BSR is referred below to as ‘Regular BSR’;
UL resources are allocated and number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.

### MAC Control Elements

MAC CE allows activation deactivation of certain configuration which are already pre-configured by higher layer such as RRC. From TS 38.321:
The MAC subheader consists of the following fields:
LCID: The Logical Channel ID field identifies the logical channel instance of the corresponding MAC SDU or the type of the corresponding MAC CE or padding as described in Tables 6.2.1-1 and 6.2.1-2 for the DL-SCH and UL-SCH respectively. There is one LCID field per MAC subheader. The size of the LCID field is 6 bits. If the LCID field is set to 34, one additional octet is present in the MAC subheader containing the eLCID field and follow the octet containing LCID field. If the LCID field is set to 33, two additional octets are present in the MAC subheader containing the eLCID field and these two additional octets follow the octet containing LCID field;
eLCID: The extended Logical Channel ID field identifies the logical channel instance of the corresponding MAC SDU or the type of the corresponding MAC CE as described in tables 6.2.1-1a, 6.2.1-1b, 6.2.1-2a and 6.2.1-2b for the DL-SCH and UL-SCH respectively. The size of the eLCID field is either 8 bits or 16 bits.

NOTE: The extended Logical Channel ID space using two-octet eLCID and the relevant MAC subheader format is used, only when configured, on the NR backhaul links between IAB nodes or between IAB node and IAB Donor.
L: The Length field indicates the length of the corresponding MAC SDU or variable-sized MAC CE in bytes. There is one L field per MAC subheader except for subheaders corresponding to fixed-sized MAC CEs, padding, and MAC SDUs containing UL CCCH. The size of the L field is indicated by the F field;
F: The Format field indicates the size of the Length field. There is one F field per MAC subheader except for subheaders corresponding to fixed-sized MAC CEs, padding, and MAC SDUs containing UL CCCH. The size of the F field is 1 bit. The value 0 indicates 8 bits of the Length field. The value 1 indicates 16 bits of the Lengthfield;
R: Reserved bit, set to 0.

There currently exist certain challenges. Improved systems and methods for measurement gaps are needed.

### SUMMARY

Systems and methods for triggering Medium Access Control (MAC) Control Element (CE) for measurement gap are provided. In some embodiments, a method performed by a User Equipment (UE) for requesting gap status change includes: generating a MAC CE that indicates a preference for a Measurement Gap (MG) state; receiving an indication from base station granting permission to the UE to trigger a scheduling request; acquiring an uplink grant by triggering a scheduling request; and after acquiring the uplink grant, transmitting the MAC CE that indicates a preference for a MG state. In this way, the UE can dispatch the MG activation/deactivation with a very low latency; i.e., as soon as the MAC CE are available; the availability of MG MAC CE can also trigger transmission; sending SR and obtaining grant to send the MAC CE. A common MAC CE design for measurement gap activation/deactivation and BSR saves latency and reduces overhead.

In some embodiments, the method includes, prior to generating the MAC CE, determining if the UE is permitted to send a MAC CE. In some embodiments, the preference for a MG state comprises: one gap ID and activation/deactivation.

In some embodiments, determining if the UE is permitted to send a MAC CE comprises: determining if scheduling request for Positioning Measurement Gap Activation/Deactivation Request is configured.

In some embodiments, triggering the scheduling request includes: triggering a scheduling request for Positioning Measurement Gap Activation/Deactivation Request MAC CE.

In some embodiments, the MAC CE includes an A/D field for specifying activation or deactivation of a MG state.

In some embodiments, the MAC CE includes a bitmap with each bit of the bitmap corresponding to a respective gap index.

In some embodiments, the MAC CE includes a prohibit timer that indicates the UE (900) should not send again the MAC CE again until the prohibit timer has expired.

In some embodiments, the MAC CE includes a retransmission timer that indicates the UE should retransmit the MAC CE.

In some embodiments, the method also includes: appending a buffer status report with the MAC CE with a deactivation MG request.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an architecture for Positioning in New Radio (NR);

FIG. 2 illustrates a User Equipment (UE) sending a Radio Resource Control (RRC) Location Measurement Indication message to the serving gNB;

FIG. 3 illustrates an example of a measurement gap pattern (MGP);

FIG. 4 shows an example of a communication system in accordance with some embodiments;

FIG. 5 illustrates a method of operating a UE, according to some embodiments of the current disclosure;

FIG. 6 illustrates a method of operating a network node, according to some embodiments of the current disclosure;

FIG. 7 illustrates a common MAC CE design;

FIG. 8 illustrates BITMAP indexes for the identifier octet of FIG. 7;

FIG. 9 shows a UE in accordance with some embodiments;

FIG. 10 shows a network node in accordance with some embodiments;

FIG. 11 is a block diagram of a host, which may be an embodiment of the host 416 of FIG. 4, in accordance with various aspects described herein;

FIG. 12 is a block diagram illustrating a virtualization environment in which functions implemented by some embodiments may be virtualized; and

FIG. 13 shows a communication diagram of a host communicating via a network node with a UE over a partially wireless connection in accordance with some embodiments.

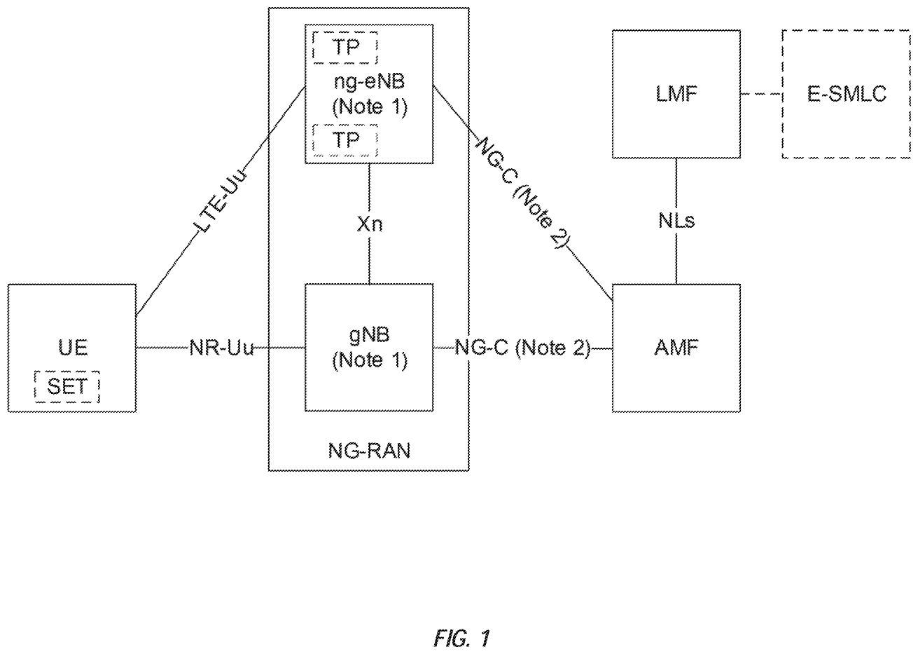

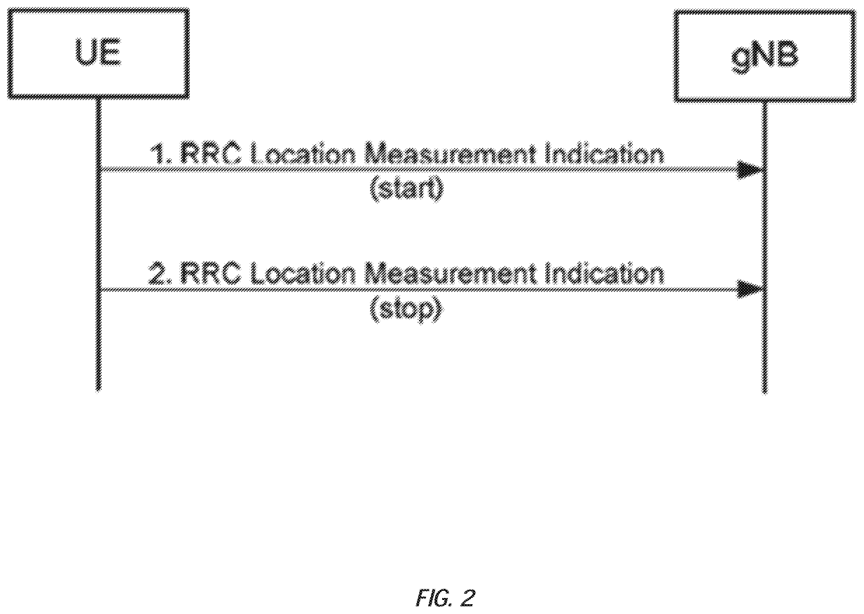

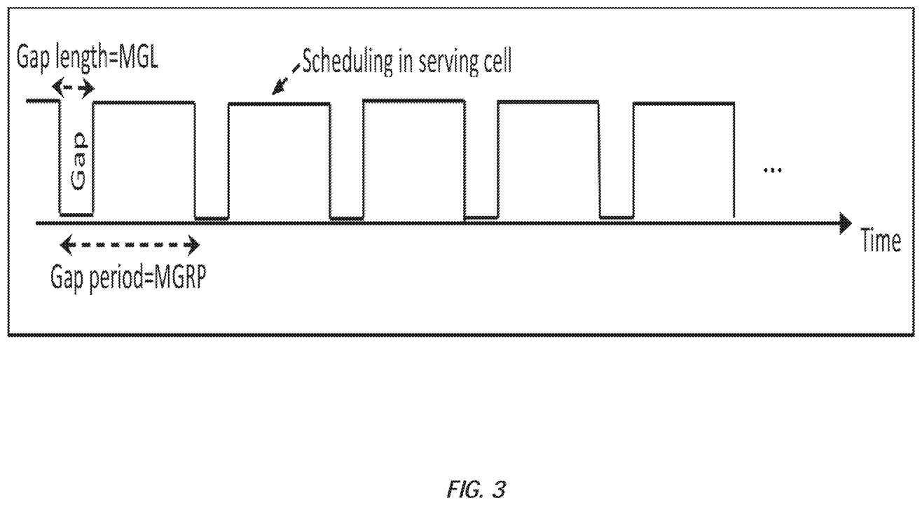

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

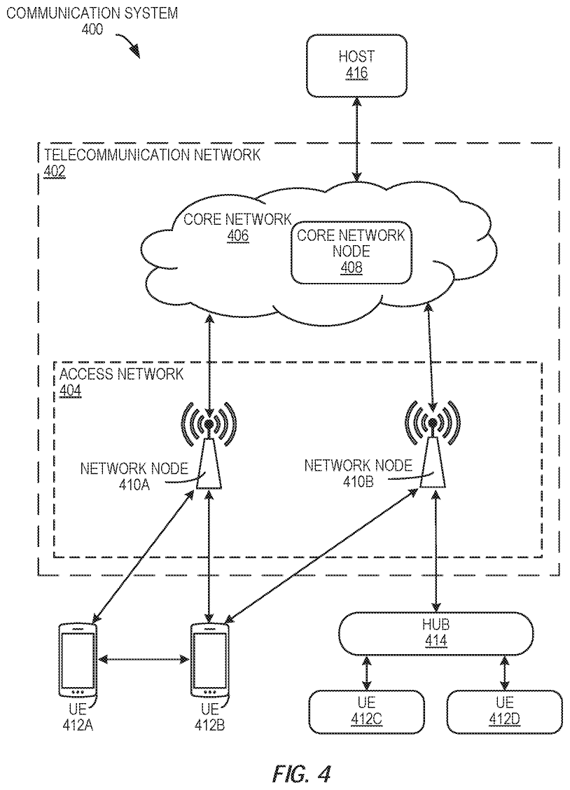

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3^{rd} Generation Partnership Project (3GPP) access node or non-3GPP access point. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

There currently exist certain challenges. As described above, an UL MAC CE will be defined which the UE can use to indicate to the network that it wants to activate or deactivate measurement gaps. It may be so that the UE will determine that a measurement gap needs to be activated and hence send the MAC CE to the network to indicate this. However, the UE will, according to current state of the art not be able to transmit such a MAC CE until the UE gets an uplink grant. The UE will not necessarily have an uplink grant shortly after the UE has decided to send the MAC CE. This means that the UE may need to wait until a later time (potentially much later time) to get an uplink grant which the UE can use to send the MAC CE. Waiting to send the MAC CE will hence introduce delays in activating or deactivating the measurement gaps. If the gaps are not activated early, the UE may not be able to perform certain procedures (e.g., positioning procedures). And if a measurement gap is not deactivated in time, it means that the UE may be configured with a measurement gap even if the UE does not need it. And that may result in that the UE is not able to communicate with the network during the (unnecessary) measurement gap.

Certain aspects of the disclosure and their embodiments may provide solutions to these or other challenges. In this disclosure, a mechanism to provide efficient MAC CE design is provided. Instead of waiting for UL grant (i.e., arrival of UL data from higher layers such as RRC which can cause a BSR to be triggered and subsequently allow to send SR); the UE MAC layer takes proactive action such as immediately triggering a SR as soon as UL MAC CE for MG activation/deactivation is ready/available. A mechanism is defined where a new scheduling request trigger is defined based upon triggering of a MAC Control element for measurement gap activation/deactivation request. In some cases, a gNB controls the UE transmitting MAC CE by configuring whether the UE is allowed to trigger Scheduling Request. In some cases, the gNB controls the UE triggering acquisition of an uplink grant for purposes of requesting a gap status change, whether that triggering is performed by triggering a scheduling request, sending a scheduling request, initiating a random access procedure, or triggering a buffer status report. A mechanism is defined where a BSR request is appended with the MAC Control element that UE needs to send for measurement gap activation/deactivation request.

Certain embodiments may provide one or more of the following technical advantages: A SR definition for MAC CE allows UE to dispatch the measurement gap activation/deactivation with a very low latency; i.e., as soon as the MAC CE are available; the availability of measurement gap (MG) MAC CE can also trigger transmission; sending SR and obtaining grant to send the MAC CE. A common MAC CE design for measurement gap activation/deactivation and BSR saves latency and reduces overhead.

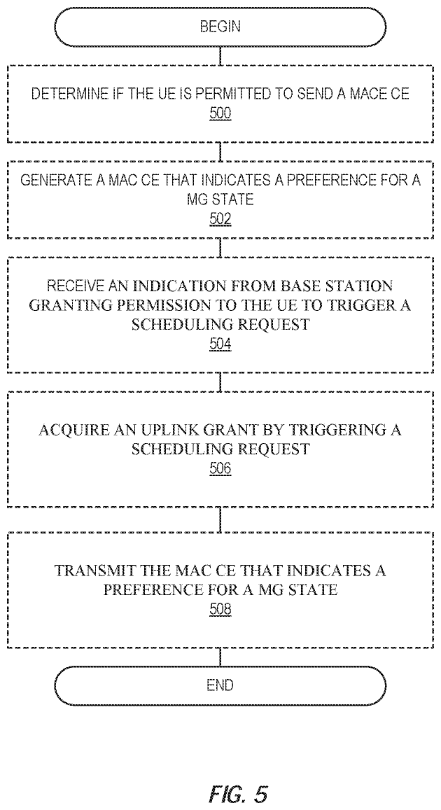

Systems and methods for triggering Medium Access Control (MAC) Control Element (CE) for measurement gap are provided. FIG. 5 illustrates a method of operating a UE, according to some embodiments of the current disclosure. In some embodiments, a method performed by a UE (900) for requesting gap status change includes: optionally determining if the UE (900) is permitted to send a MAC CE (step 500); generating a MAC CE that indicates a preference for a Measurement Gap (MG) state (step 502); receiving an indication from base station granting permission to the UE to trigger a scheduling request (step 504); acquiring an uplink grant by triggering a scheduling request (step 506); and after acquiring the uplink grant, transmitting the MAC CE that indicates a preference for a MG state (step 508). In this way, the UE can dispatch the MG activation/deactivation with a very low latency; i.e., as soon as the MAC CE are available; the availability of MG MAC CE can also trigger transmission; sending a Scheduling Request and obtaining grant to send the MAC CE. A common MAC CE design for measurement gap activation/deactivation and Buffer Status Reporting (BSR) saves latency and reduces overhead.

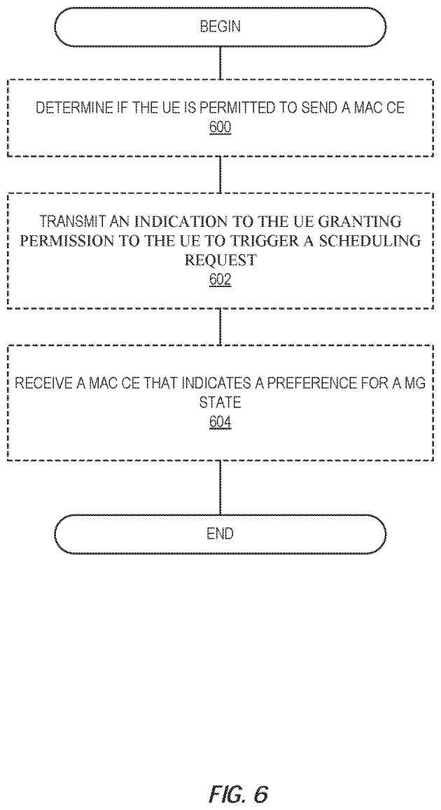

FIG. 6 illustrates a method of operating a network node, according to some embodiments of the current disclosure. In some embodiments, a method performed by a network node (1000), for controlling gap status change request by a UE (900), includes: optionally determining if the UE (900) is permitted to send a MAC CE (step 600); providing an indication, to the UE (900), granting permission to the UE (900) to trigger a scheduling request for purposes of transmitting a Medium Access Control, MAC, Control Element, CE, that indicates a preference for a Measurement Gap, MG, state (step 602); and receiving, from the UE (900), the MAC CE that indicates a preference for a MG state (step 604).

### Methods to Acquire UL Resource for Sending MAC CE Used to Request Gap Status Change

In one embodiment a UE will determine that the UE should send a MAC CE to indicate a preference for a measurement gap state (e.g., that such a MAC CE has been “triggered” in the UE). And in response to such determining the UE will take an action to acquire an uplink grant. That uplink grant (or a subsequent uplink grant) can be used to transmit the MAC CE. The reason why a subsequent uplink grant may be used to send the MAC CE may be in a case when the UE has some other higher priority data which takes precedence over the MAC CE and the uplink grant is not large enough to fit both the other data and the MAC CE.

The action to acquire an uplink grant may be to trigger/send a scheduling request. Another alternative is that the UE initiates a random access procedure. Yet another alternative is that the UE triggers a BSR.

In some cases the UE may determine that it will have a grant available, which will be valid within a certain period of time, and in such cases the UE may refrain from taking the action to acquire an uplink grant. For example, the UE may have configured uplink grants which occur periodically. And in such case it may not be beneficial or meaningful to take an action to acquire another uplink grant.

In some cases, gNB controls the UE transmitting MAC CE by configuring whether the UE is allowed to trigger Scheduling Request. Such control can be indicated, for example, by RRC or DL MAC CE by a flag bit. An example of RRC based control is provided below. This can also be seen as a way to control how rapidly the UE may transmit the UL MAC CE. Hence, toggling the flag bit the gNB can control the rate at which the UE transmits the UL MAC CE. In some cases the gNB controls the UE triggering acquisition of an uplink grant for purposes of requesting a gap status change, whether that triggering is performed by triggering a scheduling request, sending a scheduling request, initiating a random access procedure, or triggering a buffer status report.
SchedulingRequestResourceConfig
   The IE SchedulingRequestResourceConfig determines physical layer resources on PUCCH where the UE may send the dedicated scheduling request (D-SR) (see TS 38.213 [13], clause 9.2.4).

SchedulingRequestResourceConfig information element

-- ASN1START
-- TAG-SCHEDULINGREQUESTRESOURCECONFIG-START

| | |
|---|---|
| SchedulingRequestResourceConfig ::= | SEQUENCE { |

schedulingRequestResourceId
SchedulingRequestResourceId,

| | |
|---|---|
| schedulingRequestID | SchedulingRequestId, |
| periodicityAndOffset | CHOICE { |
| sym2 | NULL, |
| sym6or7 | NULL, |
| sl1 | NULL, |

-- Recurs in every slot

| | |
|---|---|
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |

}
OPTIONAL, -- Need M

| | |
|---|---|
| resource | PUCCH-ResourceId |

OPTIONAL -- Need M
}
SchedulingRequestResourceConfigExt-v1610 ::= SEQUENCE {

| | |
|---|---|
| phy-PriorityIndex-r16 | ENUMERATED {p0, |
| p1} | OPTIONAL, -- Need M |

```
  ...,
  [[
  gap-request-mac-CE-SR-Trigger-r17
ENUMERATED {allowed}
OPTIONAL -- Need M
  ]]
}
-- TAG-SCHEDULINGREQUESTRESOURCECONFIG-STOP
-- ASN1STOP
```

SchedulingRequestResourceConfig field descriptions

periodicityAndOffset
SR periodicity and offset in number of symbols or slots (see TS 38.213 [13], clause 9.2.4) The
following periodicities may be configured depending on the chosen subcarrier spacing:
SCS = 15 kHz: 2sym, 7sym, 1sl, 2sl, 4sl, 5sl, 8sl, 10sl, 16sl, 20sl, 40sl, 80sl
SCS = 30 kHz: 2sym, 7sym, 1sl, 2sl, 4sl, 8sl, 10sl, 16sl, 20sl, 40sl, 80sl, 160sl
SCS = 60 kHz: 2sym, 7sym/6sym, 1sl, 2sl, 4sl, 8sl, 16sl, 20sl, 40sl, 80sl, 160sl, 320sl
SCS = 120 kHz: 2sym, 7sym, 1sl, 2sl, 4sl, 8sl, 16sl, 40sl, 80sl, 160sl, 320sl, 640sl
sym6or7 corresponds to 6 symbols if extended cyclic prefix and a SCS of 60 kHz are configured,
otherwise it corresponds to 7 symbols.
For periodicities 2sym, 7sym and sl1 the UE assumes an offset of 0 slots.
phy-PriorityIndex
Indicates whether this scheduling request resource is high or low priority in PHY
prioritization/multiplexing handling (see TS 38.213 [13], clause 9.2.4). Value p0 indicates low
priority and value p1 indicates high priority.
resource
ID of the PUCCH resource in which the UE shall send the scheduling request. The actual
PUCCH-Resource is configured in PUCCH-Config of the same UL BWP and serving cell as this
SchedulingRequestResourceConfig. The network configures a PUCCH-Resource of PUCCH-
format0 or PUCCH-format1 (other formats not supported) (see TS 38.213 [13], clause 9.2.4)
schedulingRequestID
The ID of the SchedulingRequestConfig that uses this scheduling request resource.
gap-request-mac-CE-SR-Trigger
Indicates whether UE is allowed to trigger a scheduling request in response to triggering a MAC
CE for measurement gap activation/deactivation.

In TS 38.321 v16.7.0 below change to implement the alternative where a BSR is triggered is proposed in clause 5.4.5.

A BSR shall be triggered if any of the following events occur:
UL data, for a logical channel which belongs to an LCG, becomes available to the MAC entity; and either
   this UL data belongs to a logical channel with higher priority than the priority of any logical channel containing available UL data which belong to any LCG; or
   none of the logical channels which belong to an LCG contains any available UL data.
in which case the BSR is referred below to as ‘Regular BSR’;
UL resources are allocated and number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’
UL MAC CE for MG request activation/deactivation is available to be transmitted.

### Design Approach 1

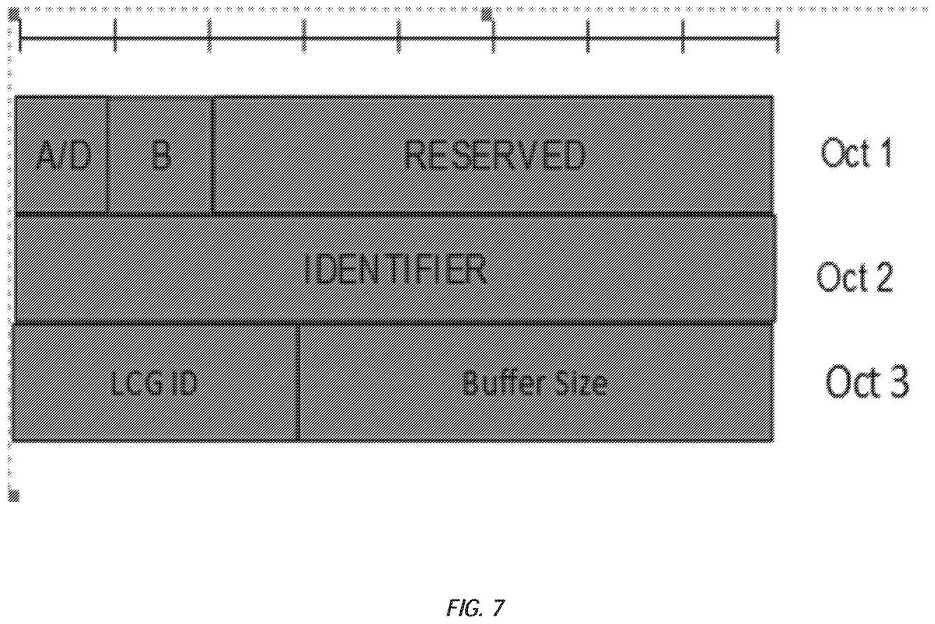

In one embodiment, a common MAC CE is used to request activation/deactivation of gap request. FIG. 7 illustrates such a MAC CE design. The fields in the MAC CE of this example are described below:
A/D: This field indicates if the MAC CE request is for activation or deactivation. If a first value (e.g., 1) is set, then the MAC CE is for activation; and if a second value is set (e.g., 0), then the MAC CE is for deactivation. The A/D field is for activating/deactivating a preconfigured measurement gap or a PRS processing window depending on what is indicated in the G/P field.
B: This field indicates if the MAC CE includes BSR. If the field is set to a first value (e.g., 0), then the MAC CE does not include BSR. If the field is set to a second value (e.g., 1), then the MAC CE includes BSR.
IDENTIFIER: This fields indicates the ID of a preconfigured measurement gap to be activated/deactivated.

### Design Approach 2

In one embodiment the MAC CE which the UE can use to indicate its preference for gap activation/deactivation can look like this:

There is a bitmap in the MAC CE. Each bit in the bitmap corresponds to a certain gap index. The network would configure an index for each gap configuration. The indices can span from e.g., 0 to 15. The bitmap would have 16 bits. The first bit (e.g., the Least significant bit) would be corresponding to the gap configuration with index 0, the second bit to the gap configuration with index 1, and so on.

If the UE wants the gap with index N to be in an activated state, the UE will set the corresponding bit to 1, otherwise it would set the bit to 0. For example, if the UE wants that gap 1 and gap 5 should be activated (while the other gaps should be deactivated), the UE will set bits for gap 1 and gap 5 to 1, while the rest of the bits would be set to 0. If the UE would at a later stage instead want gap 1 and gap 3 to be activated, the UE would set the bits for gap 1 and gap 3 to 1, while the rest of the bits would be set to 0. Note: in this scenario the UE wants gap 1 to remain activated (while gap 5 should become deactivated and gap 3 to be activated) and hence the bit corresponding to gap 1 would remain as 1 in the second instance of this MAC CE.

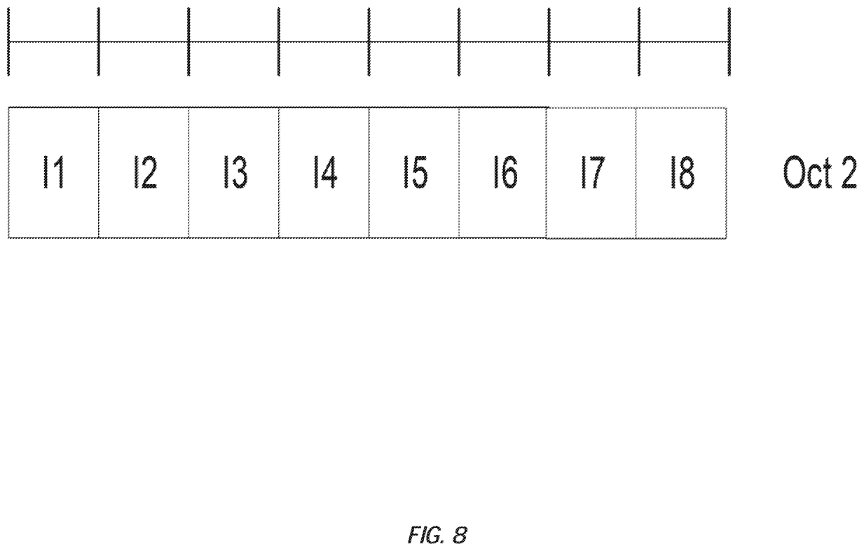

If the UE does not have a gap configured that has index N, the UE may set the corresponding bit to 0. In the “MAC CE design” of FIG. 7, the identifier octet could be represented as the BITMAP indexes in FIG. 8, according to some embodiments.

### Prohibit Timer

To avoid that the UE sends these MAC CEs unnecessarily and hence waste radio resources, in one embodiment the network configures a timer which forbids the UE from sending this MAC CE again until the timer has expired. This timer may be referred to as a prohibit timer.

In one version of this embodiment, the UE is allowed to bypass/ignore the prohibit timer if the content of the message has changed compared to the last time the UE sent the MAC CE. For example, if the UE sent the MAC CE with a certain content at time T, the UE would not be allowed to send the MAC CE with the same content until a time T+prohibit_timer. However, if the UE's preference (and hence the content of the MAC CE) would change, the UE would be allowed to send the MAC CE even if the prohibit timer is running.

The UE may start the prohibit timer whenever the UE sends the MAC CE.

The duration of the prohibit timer may be configured by the network, e.g., using RRC signalling.

### Retransmission Timer

MAC CEs may be lost when transmitted from the UE to the network (or in the other direction as well for that matter, even if downlink is not the focus of the methods in this document). To protect against this, according to this embodiment the UE may retransmit the MAC CE. The UE may not know that the MAC CE was lost, however if the UE sent the MAC CE to the network and the network did not take any action of activating/deactivating gaps for the UE, there is a chance that the MAC CE was lost. Hence the UE may according to this embodiment retransmit the MAC CE a time T after the UE sent the MAC CE unless the network has activated/deactivated gaps for the UE during this time T.

In one version of this embodiment, the UE will retransmit the MAC CE unless the network activated/deactivated the gaps exactly as indicated by the UE's preference that the MAC CE indicated. For example, if the UE indicated that it preferred to activate gap 5, the UE will retransmit the MAC CE if the network has not activated gap 5 before the time T has passed since the UE sent the MAC CE.

In another version of this embodiment, the UE will refrain from retransmitting the MAC CE if the network has performed any type of gap activation/deactivation. For example, if the UE indicated it preferred to activate gap 5, the UE would retransmit the MAC CE but only in case no gap activation/deactivation has happened within a time T since the UE sent the MAC CE.

The UE may start the retransmission timer whenever the UE sends the MAC CE. And at expiry the UE resends the MAC CE. However, the timer is stopped by the UE when the NW activates/deactivates gaps (see the two versions of the embodiment above).

The duration of the retransmission timer may be configured by the network, e.g., using RRC signalling.

### BSR and UL Grant Handling BSR and UL Grant Handling

In an embodiment it is claimed that if the UE asks for measurement gap activation; depending upon gap configuration (how big is the length and periodicity of the gap); gNB identifies the size of measurement report and can provide UL grant accordingly to the UE to provide the measurements.

In a separate embodiment it is claimed that UE appends the BSR when it sends MAC CE with deactivation MG request. Sending deactivation implies UE has completed the measurement and thus it needs to send measurement report; it should be aware of how much data that it needs to transmit. Hence, in order to save latency, it appends the BSR also with the MAC CE. Otherwise, UE may have to send multiple MAC CE; one for deactivation and other for the dedicated BSR.

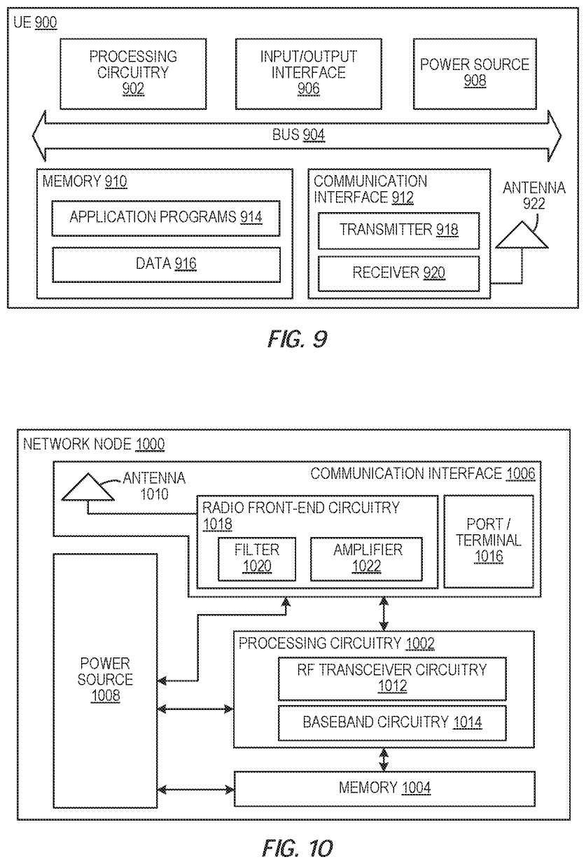

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

FIG. 11 is a block diagram of a host 1100, which may be an embodiment of the host 416 of FIG. 4, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

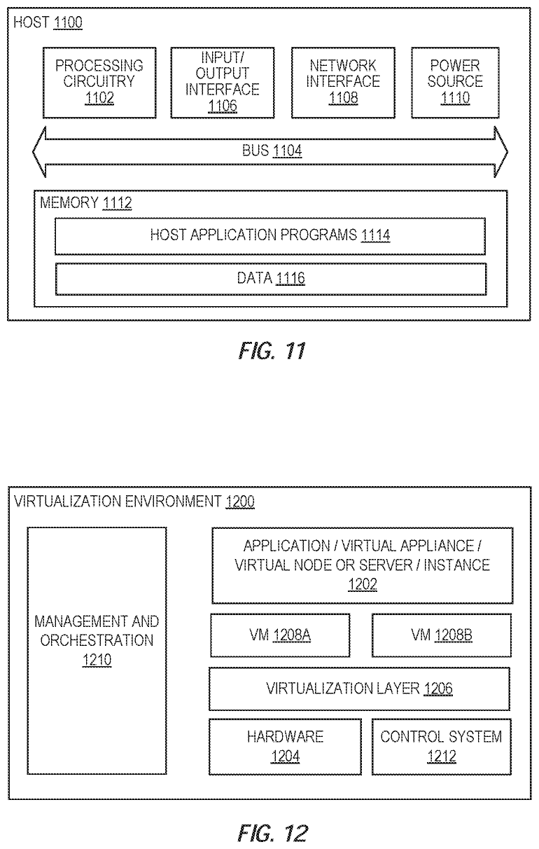

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g., such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

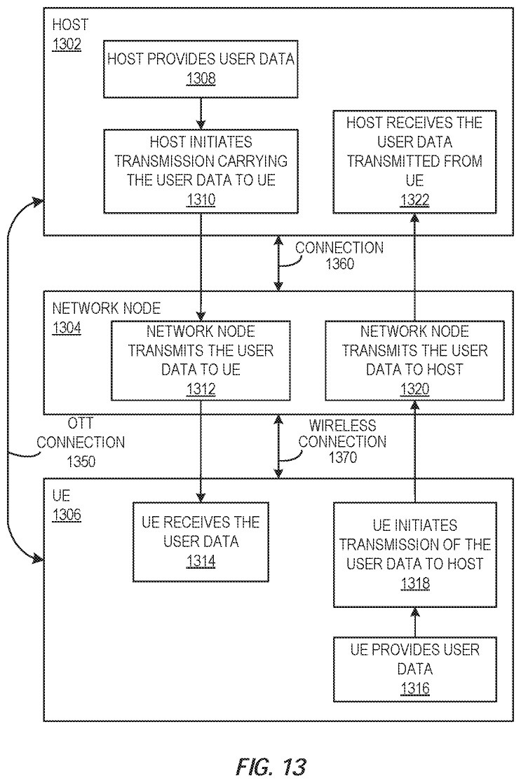

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 412a of FIG. 4 and/or UE 900 of FIG. 9), network node (such as network node 410a of FIG. 4 and/or network node 1000 of FIG. 10), and host (such as host 416 of FIG. 4 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 406 of FIG. 4) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve e.g., the data rate, latency, and power consumption, and thereby provide benefits such as reduced user waiting time, relaxed restriction on file size, improved content resolution, better responsiveness, and extended batter lifetime.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

Embodiment 1: A method performed by a user equipment for requesting gap status change, the method comprising: generating a Medium Access Control, MAC, Control Element, CE, that indicates a preference for a measurement gap state; receiving an indication from base station granting permission to the user equipment to trigger acquisition of an uplink grant for purposes of requesting a gap status change; taking action to acquire an uplink grant, wherein taking action to acquire an uplink grant comprises one of: triggering a scheduling request, sending a scheduling request, initiating a random access procedure, and triggering a buffer status report; and after acquiring the uplink grant, transmitting the MAC CE that indicates a preference for a measurement gap.

Embodiment 2: A method performed by a user equipment for requesting gap status change, the method comprising: generating a Medium Access Control, MAC, Control Element, CE, that indicates a preference for a measurement gap state; receiving an indication from base station granting permission to the user equipment to trigger a scheduling request; acquiring an uplink grant by triggering a scheduling request; and after acquiring the uplink grant, transmitting the MAC CE that indicates a preference for a measurement gap.

Embodiment 3: A method performed by a user equipment for requesting gap status change, the method comprising: generating a Medium Access Control, MAC, Control Element, CE, that indicates a preference for a measurement gap state; taking action to acquire an uplink grant, wherein taking action to acquire an uplink grant comprises triggering a buffer status report that comprises an uplink MAC CE for MG request activation/deactivation; and after acquiring the uplink grant, transmitting the MAC CE that indicates a preference for a measurement gap.

Embodiment 4: The method of any of embodiments 1, 2, or 3, wherein the MAC CE includes an A/D field for specifying activation or deactivation of a measurement gap.

Embodiment 5: The method of embodiment 1, 2, or 3, wherein the MAC CE includes a bitmap with each bit of the bitmap corresponding to a respective gap index.

Embodiment 6: The method of embodiment 1, wherein taking action comprises triggering a scheduling request.

Embodiment 7: The method of embodiment 1, wherein taking action comprises sending a scheduling request.

Embodiment 8: The method of embodiment 1, wherein taking action comprises initiating a random access procedures.

Embodiment 10: The method of embodiment 1, 2, or 3, wherein the MAC CE includes a prohibit timer that indicates the user equipment should not send again the MAC CE again until the timer has expired.

Embodiment 11: The method of embodiment 1, 2, or 3, wherein the MAC CE includes a retransmission timer that indicates the user equipment should retransmit the MAC CE.

Embodiment 12: The method of embodiment 3, and further comprising the user equipment appending a buffer status report with the MAC CE with a deactivation MG request.

Embodiment 13: The method of embodiment 1, 2, or 3, further comprising the user equipment appending a buffer status report with the MAC CE with a deactivation MG request.

Embodiment 14: The method of any of the previous embodiments, further comprising: providing user data; and forwarding the user data to a host via the transmission to the network node.

### Group B Embodiments

Embodiment 15: A method performed by a network node for controlling gap status change request by a user equipment, the method comprising: providing an indication granting permission to the user equipment to trigger acquisition of an uplink grant for purposes of requesting a gap status change; and receiving, from the user equipment, a MAC CE that indicates a preference for a measurement gap.

Embodiment 16: A method performed by a network node for controlling gap status change request by a user equipment, the method comprising: providing an indication granting permission to the user equipment to trigger a scheduling request for purposes of transmitting a MAC CE that indicates a preference for a measurement gap; and receiving, from the user equipment, a MAC CE that indicates a preference for a measurement gap.

Embodiment 17: The method of embodiment 15 or 16, wherein the MAC CE includes an A/D field for specifying activation or deactivation of a measurement gap.

Embodiment 18: The method of embodiment 15 or 16, wherein the MAC CE includes a bitmap with each bit of the bitmap corresponding to a respective gap index.

Embodiment 19: The method of embodiment 15 or 16, wherein the MAC CE includes a prohibit timer that indicates the user equipment should not send again the MAC CE again until the timer has expired.

Embodiment 20: The method of embodiment 15 or 16, wherein the MAC CE includes a retransmission timer that indicates the user equipment should retransmit the MAC CE.

Embodiment 21: The method of embodiment 15 or 16, and further comprising receiving a buffer status report appended with the MAC CE with a deactivation MG request.

Embodiment 22: The method of any one of the embodiments 15-21, further comprising: obtaining user data; and forwarding the user data to a host or a user equipment.

### Group C Embodiments

Embodiment 23: A user equipment for requesting gap status change, comprising: processing circuitry configured to perform any of the steps of any of the Group A embodiments; and power supply circuitry configured to supply power to the processing circuitry.

Embodiment 24: A network node for controlling gap status change request by a user equipment, the network node comprising: processing circuitry configured to perform any of the steps of any of the Group B embodiments; power supply circuitry configured to supply power to the processing circuitry.

Embodiment 25: A user equipment (UE) for requesting gap status change, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 26: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 27: The host of the previous embodiment, wherein the cellular network further includes a network node configured to communicate with the UE to transmit the user data to the UE from the host.

Embodiment 28: The host of the previous 2 embodiments, wherein: the processing circuitry of the host is configured to execute a host application, thereby providing the user data; and the host application is configured to interact with a client application executing on the UE, the client application being associated with the host application.

Embodiment 29: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 30: The method of the previous embodiment, further comprising: at the host, executing a host application associated with a client application executing on the UE to receive the user data from the UE.

Embodiment 31: The method of the previous embodiment, further comprising: at the host, transmitting input data to the client application executing on the UE, the input data being provided by executing the host application, wherein the user data is provided by the client application in response to the input data from the host application.

Embodiment 32: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 33: The host of the previous embodiment, wherein the cellular network further includes a network node configured to communicate with the UE to transmit the user data from the UE to the host.

Embodiment 34: The host of the previous 2 embodiments, wherein: the processing circuitry of the host is configured to execute a host application, thereby providing the user data; and the host application is configured to interact with a client application executing on the UE, the client application being associated with the host application.

Embodiment 35: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 36: The method of the previous embodiment, further comprising: at the host, executing a host application associated with a client application executing on the UE to receive the user data from the UE.

Embodiment 37: The method of the previous embodiment, further comprising: at the host, transmitting input data to the client application executing on the UE, the input data being provided by executing the host application, wherein the user data is provided by the client application in response to the input data from the host application.

Embodiment 38: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 39: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 40: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 41: The method of the previous embodiment, further comprising, at the network node, transmitting the user data provided by the host for the UE.

Embodiment 42: The method of any of the previous 2 embodiments, wherein the user data is provided at the host by executing a host application that interacts with a client application executing on the UE, the client application being associated with the host application.

Embodiment 43: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 44: The communication system of the previous embodiment, further comprising: the network node; and/or the user equipment.

Embodiment 45: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 46: The host of the previous 2 embodiments, wherein: the processing circuitry of the host is configured to execute a host application, thereby providing the user data; and the host application is configured to interact with a client application executing on the UE, the client application being associated with the host application.

Embodiment 47: The host of the any of the previous 2 embodiments, wherein the initiating receipt of the user data comprises requesting the user data.

Embodiment 48: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 49: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
A/D Activation/Deactivation
AF Application Function
AMF Access and Mobility Function
AN Access Network
AP Access Point
ASIC Application Specific Integrated Circuit
AUSF Authentication Server Function
BSR Buffer Status Reporting
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
ID Identification
IoT Internet of Things
IP Internet Protocol
LTE Long Term Evolution
MAC Medium Access Control
MG Measurement Gap
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
SR Scheduling Request
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a User Equipment, UE, for requesting gap status change, the method comprising:
generating a Medium Access Control, MAC, Control Element, CE, that indicates a preference for a Measurement Gap, MG, state;
receiving an indication from a base station granting permission to the UE to trigger a scheduling request;
acquiring an uplink grant by triggering the scheduling request; and
after acquiring the uplink grant, transmitting the MAC CE that indicates the preference for the MG state.

2. The method of claim 1 further comprising:
prior to generating the MAC CE, determining if the UE is permitted to send the MAC CE.

3. The method of claim 1 wherein the preference for the MG state comprises: one gap identification, ID, and activation/deactivation.

4. The method of claim 2 wherein determining if the UE is permitted to send the MAC CE comprises: determining if the scheduling request for a Positioning Measurement Gap Activation/Deactivation Request is configured.

5. The method of claim 1 wherein triggering the scheduling request comprises: triggering the scheduling request for the Positioning Measurement Gap Activation/Deactivation Request for the MAC CE.

6. The method of claim 1, wherein the MAC CE includes one or more of:
an Activation/Deactivation, A/D, field for specifying activation or deactivation of the MG state;
a bitmap with each bit of the bitmap corresponding to a respective gap index; and
a prohibit timer that indicates the UE should not send the MAC CE again until the prohibit timer has expired.

7. (canceled)

8. (canceled)

9. The method of claim 1, wherein the MAC CE includes a retransmission timer that indicates the UE should retransmit the MAC CE.

10. The method of claim 1, further comprising:
appending a buffer status report with the MAC CE with a deactivation MG request.

11. A method performed by a network node, for controlling a gap status change request by a User Equipment, UE, the method comprising:
providing an indication, to the UE, granting permission to the UE to trigger a scheduling request for purposes of transmitting a Medium Access Control, MAC, Control Element, CE, that indicates a preference for a Measurement Gap, MG, state; and
receiving, from the UE, the MAC CE that indicates the preference for the MG state.

12. The method of claim 11 further comprising:
prior to providing the indication, determining if the UE is permitted to send the MAC CE.

13. The method of claim 11 wherein the preference for the MG state comprises: one gap identification, ID, and activation/deactivation.

14. The method of claim 12 wherein determining if the UE is permitted to send the MAC CE comprises: determining if the scheduling request for a Positioning Measurement Gap Activation/Deactivation Request is configured.

15. The method of claim 11 wherein triggering the scheduling request comprises: triggering the scheduling request for the Positioning Measurement Gap Activation/Deactivation Request for the MAC CE.

16. The method of claim 11, wherein the MAC CE includes an Activation/Deactivation, A/D, field for specifying activation or deactivation of the MG state.

17. The method of claim 11, wherein the MAC CE includes a bitmap with each bit of the bitmap corresponding to a respective gap index.

18. The method of claim 11, wherein the MAC CE includes a prohibit timer that indicates the UE should not send the MAC CE again until the prohibit timer has expired.

19. The method of claim 11, wherein the MAC CE includes a retransmission timer that indicates the UE should retransmit the MAC CE.

20. The method of claim 11, wherein the MAC CE further comprises: a buffer status report with the MAC CE with a deactivation MG request.

21. A User Equipment, UE, for requesting a gap status change, comprising:
processing circuitry configured to perform the steps of:
generating a Medium Access Control, MAC, Control Element, CE, that indicates a preference for a Measurement Gap, MG, state;
receiving an indication from a base station granting permission to the UE to trigger a scheduling request;
acquiring an uplink grant by triggering the scheduling request; and
after acquiring the uplink grant, transmitting the MAC CE that indicates the preference for the MG state.

22. (canceled)

23. A network node, for controlling a gap status change request by a User Equipment, UE, comprising:
processing circuitry configured to:
provide an indication, to the UE, granting permission to the UE to trigger a scheduling request for purposes of transmitting a Medium Access Control, MAC, Control Element, CE, that indicates a preference for a Measurement Gap, MG, state;
receive, from the UE, the MAC CE that indicates the preference for the MG state.

24. (canceled)
